(19) United States
(12) Patent Application Publication
(10) Pub. No.: US 2016/0291826 A1
(43) Pub. Date: Oct. 6, 2016

(54) STANDALONE AND DISTRIBUTED APPLICATION FOR SIMULATION OF INTERNET OF THINGS (IoT) SCENARIOS

(71) Applicant: Nemrude Verzano, St Leon-Rot (DE)

(72) Inventor: Nemrude Verzano, St Leon-Rot (DE)

(21) Appl. No.: 14/672,374

(22) Filed: Mar. 30, 2015

(51) Int. Cl. G06F 3/0488; G06F 3/0484

(52) U.S. Cl. CPC G06F 3/0488; G06F 3/04847

(57) ABSTRACT

The present disclosure involves systems and computer implemented methods for creating and managing standalone and distributed models and simulations of Internet of Things (IoT) scenarios. In one example, the method can include presenting a visualization of a model representing an Internet of Things (IoT) scenario on a touch-capable display, the IoT scenario comprising a model of a location and two or more components, the touch-capable display capable of receiving touch-based input from a user interacting with the presented visualization via the display, identifying a selection of a particular component within the IoT scenario via a touch-based command, the touch-based command corresponding to a touch of the particular component within the presented visualization, receiving input defining a modified behavior of the particular component within the IoT scenario, and executing the IoT scenario based on the modified behavior of the particular component.

### BACKGROUND

The present disclosure relates to computer systems and computer-implemented methods for creating and managing standalone and distributed models and simulations of Internet of Things (IoT) scenarios.

The Internet of Things is a network of physical objects, or “things,” embedded within electronics, software, sensors, and connectivity to enable and achieve greater value and service by exchanging data with the manufacturer, operator, and/or other connected devices or systems. Each thing can be uniquely identifiable through its embedded computing system, and can interoperate through the existing Internet or local network infrastructure. In many cases, implementations of the Internet of Things can provide services including machine-to-machine communications (M2M), such that information received from one machine can influence or modify the actions and activities of other machines.

### SUMMARY

The present disclosure involves systems, software, and computer-implemented methods for creating and managing standalone and distributed models and simulations of Internet of Things (IoT) scenarios. One computer-implemented method includes: presenting a visualization of a model representing an Internet of Things (IoT) scenario on a touch-capable display, the IoT scenario comprising a model of a location and two or more components, the touch-capable display capable of receiving touch-based input from a user interacting with the presented visualization via the display, identifying a selection of a particular component within the IoT scenario via a touch-based command, the touch-based command corresponding to a touch of the particular component within the presented visualization, receiving input defining a modified behavior of the particular component within the IoT scenario, and executing the IoT scenario based on the modified behavior of the particular component.

While generally described as computer-implemented software embodied on non-transitory, tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for creating and managing standalone and distributed models and simulations of Internet of Things (IoT) scenarios.

FIG. 2 is a flowchart of example operations performed to modify a simulation of an IoT scenario.

FIG. 3 is a flowchart of example operations performed to add a new component to an existing IoT scenario.

FIG. 4 is a swim lane diagram of example operations performed in response to a modification to an IoT scenario.

FIGS. 5A-D are illustrative screenshots related to the creation, modification, and simulation of IoT scenarios.

### DETAILED DESCRIPTION

The present disclosure describes systems and tools for generating, maintaining, and presenting simulations of an Internet of Things (IoT) simulator. For demo environments with machines, devices, and things interacting with one another, especially in the environment of IoT, it is a challenge to have real machines, devices, and things available to implement, manage, and execute interactions between them. In some instances, the difficulty lies in the price to obtain the set of machines, devices, and things to be included in a particular scenario, much less the time and effort in being able to test and adjust the systems once they are purchased. The latter would add significant manual labor to the purchase price of such materials. Still further, the implementation of IoT scenarios in the real world can require significant expertise in IT, electronics, mechanics, programming, and other fields. The present solution and associated tools not only reduce the costs (both capital costs and labor), but also significantly simplify operations to set up content to be used at events, deal discussions, and planning situations. For example, estimating the technical feasibilities of different kinds of approaches can be managed with relative ease as compared to the full implementation. Furthermore, the present solution can incorporate generated data from functioning systems, emulated data from existing systems, and simulated data from simulated and modeled components, thereby allowing for predicted analytics and analysis to be performed on model scenarios without the cost or time associated with traditional implementation.

The present solution is based on a software development kit used to model systems on mobile and desktop systems based on a catalog of available machines, devices, and things, which in turn are connected to or associated with either real, simulated, or emulated inputs and outputs corresponding to the devices. The software tool allows for 2D and 3D modeling of various machines, devices, and/or things, while also providing the ability to subscribe to and/or publish real or simulated data from the modeled devices. The modeling of the machines, devices, and things can be based on a model derived from real objects, such that proportions and imagery associated with the actual device being modeled can be represented within the visualization of the IoT scenario. Further, already modeled IoT scenarios can be easily modified or tweaked by adding new things to the IoT scenario or simulating modified behavior of one or more of the machines, devices, or things. Based on this, the modeling application can be used in any suitable industry and to define any suitable IoT scenarios based on 2D- or 3D-models of the devices being simulated and real or simulated data associated with the operation of those things.

In one example, SAP SE's 3D Visual Enterprise (VE) application may be used to enable the described functionality. Using VE, easy interactions with any modeled components can be simulated to invoke different features and operations. Using VE or a similar modeling application, different connections between parts of a modeled scenario can be explored, added, removed, or otherwise modified. Additionally, connections can be assigned between components in different models on different devices, particularly when they are in the same network and are connected with each other (e.g., via an m2m/IoT platform). With these capabilities, any suitable scenario and/or interaction can be created and made visible to users as needed, while making the software and interactions capable of being executed on any suitable device as web-based and/or mobile applications. Other suitable 3D or 2D viewers may also be used to support the IoT scenario simulation, as appropriate.

In some instances, and to provide an additionally usable solution, the primary user interface can be based on a tablet or other mobile device and allow for a touch and play approach. The complex code implementation of establishing connections to other sensors, applications, components, and/or platform and to publish or subscribe to certain device-related data and information is hidden behind touch user interfaces which allow any suitable model or component within the visualized scenario a sensor, data producer, or data consumer.

In order to define a specific component of a model, the modeled component can be tapped or touched, where options are presented to define the component as a sensor (i.e., generating simulated or randomized data corresponding to the component) or as a consumer of data being provided by another real or virtual sensor. Managing the interactions between the different virtual and real sensors allows detailed simulated IoT scenarios to be created and/or maintained by users without advanced technical skills or know-how. The data and interaction management operations can use different types of connection protocols depending on the usage of the application. For example, an online option of connecting to an IoT or m2m (machine-to-machine) platform using Hypertext Transfer Protocol (http) or Transmission Control Protocol (tcp) communications can be used. In another option, connections to different tablets and/or smartphones using tcp can be used. Still further, in an offline solution, the devices can be used in a standalone manner to connect to one or more devices directly, in a simulation without additional devices, or via Bluetooth or other device-to-device communications. Using the solution, simple message management between different kinds of applications interacting with each other is possible, regardless of whether those applications are virtual or real devices or components. The use of random generators or simulated data allows the solution to create virtual sensors easily based on very few simple interactions.

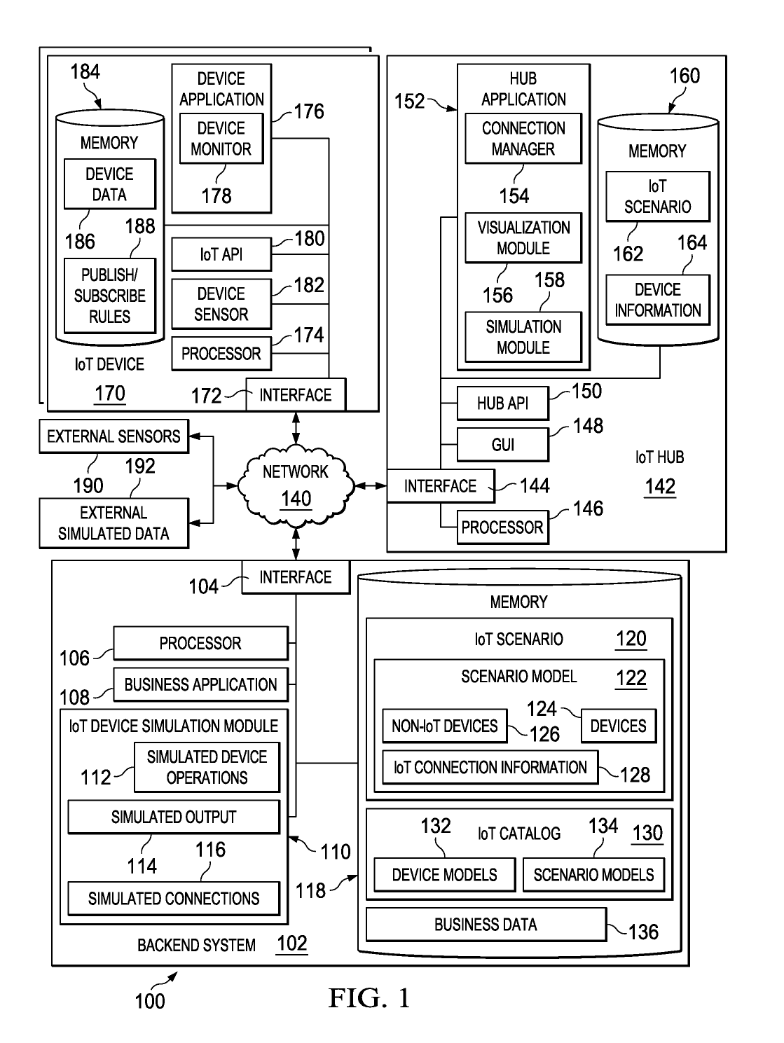

Turning to the illustrated embodiment, FIG. 1 is a block diagram 100 illustrating an example system for creating and managing standalone and distributed models and simulations of Internet of Things (IoT) scenarios. As illustrated in FIG. 1, system 100 is a multi-component system capable of interacting with different devices via network 140. In one instance, an IoT hub 142 may manage an IoT scenario and associated operations between a plurality of IoT devices 170 and simulations executed at one or more backend systems 102, IoT devices 170, the IoT hub 142 itself, or other external sensors 190 and external simulated data 192. In other instances, the IoT scenario may be managed by a backend system (e.g., backend system 102), which can provide visualizations of particular IoT scenarios to the IoT hub 142 for viewing and manipulation.

System 100 as illustrated includes or is communicably coupled with backend system 102, IoT hub 142, one or more IoT devices 170, and network 140. Although components are shown individually, in some implementations, functionality of two or more components, systems, or servers may be provided by a single component, system, or server. Similarly, in some implementations, the functionality of one illustrated component, system, or server may be provided by multiple components, systems, servers, or combinations thereof. Conversely, multiple components may be combined into a single component, system, or server, where appropriate.

As used in the present disclosure, the term “computer” is intended to encompass any suitable processing device. For example, backend system 102 may be any computer system, computer, or processing device such as, for example, a blade server, general-purpose personal computer (PC), Mac®, workstation, UNIX-based workstation, or any other suitable device. Moreover, although FIG. 1 illustrates backend system 102 as a single system, backend system 102 can be implemented using two or more computers, systems, as well as computers other than servers, including a server pool. In other words, the present disclosure contemplates computers other than general-purpose computers, as well as computers without conventional operating systems. Further, illustrated backend system 102, IoT hub 142, and IoT device 170 may each be adapted to execute any operating system, including Linux, UNIX, Windows, Windows Phone, Mac OS X®, Java™, Android™, or iOS. According to one implementation, the illustrated systems may also include or be communicably coupled with a communication server, an e-mail server, a web server, a caching server, a streaming data server, and/or other suitable server or computer.

In general, IoT hub 142 may be any computing device operable to connect to or communicate with one or more IoT devices 170, the backend system 102, other devices or data sources external to network 140 (e.g., external sensors 190 or external simulated data 192), and or other components via network 140, as well as with the network 140 itself, using a wireline or wireless connection. The IoT hub 142 can be any suitable system, and may be implemented as a mobile device (e.g., a tablet or smartphone). In other instances, the IoT hub 142 can include a desktop computer, a server, or any other suitable computing device. In general, IoT hub 142 comprises an electronic computer device operable to receive, transmit, process, and store any appropriate data associated with the environment 100 of FIG. 1 and at least one IoT scenario 162.

As illustrated, the IoT hub 142 includes an interface 144, a processor 146, a graphical user interface (GUI) 148, a hub API 150, a hub application 152, and memory 160. The interface 144 is used by the IoT hub 142 for communicating with other systems in a distributed environment—including within the environment 100—connected to the network 140, e.g., other IoT devices 170, the backend system 102, and other systems communicably coupled to the network 140. Generally, the interface 144 comprises logic encoded in software and/or hardware in a suitable combination and operable to communicate with the network 140. More specifically, the interface 144 may comprise software supporting one or more communication protocols associated with communications such that the network 140 or interface's hardware is operable to communicate physical signals within and outside of the illustrated environment 100.

Network 140 facilitates wireless or wireline communications between the components of the environment 100 (i.e., between the IoT hub 142, IoT devices 170, and the backend system 102, between different IoT devices 170, etc.), as well as with any other local or remote computer, such as additional clients, servers, or other devices communicably coupled to network 140, including those not illustrated in FIG. 1. In the illustrated environment, the network 140 is depicted as a single network, but may be comprised of more than one network without departing from the scope of this disclosure, so long as at least a portion of the network 140 may facilitate communications between senders and recipients. In some instances, one or more of the illustrated components may be included within network 140 as one or more cloud-based services or operations. The network 140 may be all or a portion of an enterprise or secured network, while in another instance, at least a portion of the network 140 may represent a connection to the Internet. In some instances, a portion of the network 140 may be a virtual private network (VPN). Further, all or a portion of the network 140 can comprise either a wireline or wireless link. Example wireless links may include 802.11ac/ad/af/a/b/g/n, 802.20, WiMax, LTE, and/or any other appropriate wireless link. In other words, the network 140 encompasses any internal or external network, networks, sub-network, or combination thereof operable to facilitate communications between various computing components inside and outside the illustrated environment 100. The network 140 may communicate, for example, Internet Protocol (IP) packets, Frame Relay frames, Asynchronous Transfer Mode (ATM) cells, voice, video, data, and other suitable information between network addresses. The network 140 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the IoT hub 142 includes a processor 146. Although illustrated as a single processor 146 in FIG. 1, two or more processors may be used according to particular needs, desires, or particular implementations of the environment 100. Each processor 146 may be a central processing unit (CPU), an application-specific integrated circuit (ASIC), a field-programmable gate array (FPGA), or another suitable component. Generally, the processor 146 executes instructions and manipulates data to perform the operations of the IoT hub 142. Specifically, the processor 146 executes the algorithms and operations described in the illustrated figures, including the operations performing the functionality associated with the IoT hub 142 generally, as well as the various software modules (e.g., the hub application 152), including the functionality for sending communications to and receiving transmissions from the IoT devices 170 and the backend system 102.

The hub application 152 of the IoT hub 142 represents an application, set of applications, software, software modules, or combination of software and hardware used to perform operations related to managing, visualizing, modifying, and executing particular IoT scenarios 162. In the present solution, the hub application 152 can perform operations including creating and managing connections with one or more IoT devices 170, the backend system 102, and external components and data sources. Those managed connections and information sources can then be used to generate, maintain, and interact with the IoT scenario 162. As illustrated, the hub application 152 includes a connection manager 154, a visualization module 156, and a simulation module 158. The connection manager 154 manages connections to both physical IoT devices 170 and simulated IoT devices, allowing for information to freely flow between components included in the IoT scenario 162. While the hub application 152 is illustrated as including the three components (the connection manager 154, the visualization module 156, and the simulation module 158), one or more of the components can be combined into a single component in some instances, while in others, additional and/or alternative components may be used instead.

In some instances, the connection manager 154 can allow the hub application 152 to connect directly to a particular IoT device 170, allowing the hub application 152 to receive information from or broadcast information to that particular device 170, as required. In other instances, the connection manager 154 can connect one or more external sensors 190 or external simulated data 192 with the current IoT scenario 162 and its one or more devices 170 or the hub 142 itself. Further, the connection manager 154 can receive simulated data and information from either a simulation module 158 at the hub 142 or from an IoT device simulation module 110 executing at one or more backend systems 102. In some instances, one of the IoT devices 170, in addition to any actual physical data being generated, can also simulate data or information that can be incorporated into the IoT scenario 162 managed by the hub application 152.

The visualization module 156 of the hub application 152 provides visualizations of the IoT scenario 162 being modeled, including an illustration of a particular space or location associated with the IoT scenario 162, as well as the modeled and/or simulated components (e.g., simulated IoT devices and IoT devices 170) within that location. In some instances, one or more of the components or data streams that may be subscribed from or published to may exist outside of the illustrated environment. Appropriate placeholders or other indications of this, as necessary, can be included in the visualization. The visualization itself can be created based on one or more modeled components, such as those included in an IoT catalog (e.g., IoT catalog 130) or through other visualization applications. The models may be 2D or 3D depending on the implementation, and can be positioned in the visualization in a manner similar to the way already-existing components are arranged in the actual physical location, in locations where the components may be moved, or where new components may be added. By providing the visualization, users—whether technical or business users—can envision, plan, and test IoT scenarios without requiring the extensive setup costs of adding even a single IoT component into their current or future environments. In some instances, one or more non-IoT devices may also be modeled within the IoT scenario 162, where those devices are visually illustrated within the visualized location, but are not connected to or broadcasting their own information. The present solution may allow users to modify non-IoT devices into IoT devices within the IoT scenario 162 by associating one or more activities or functionality to the previously non-IoT device(s).

The simulation module 158 of the hub application 152 allows for the IoT scenario 162 to include one or more simulated components. The data from the simulated components may be generated within the simulated module 158, from one or more external sets of simulated data 192, or from an IoT device simulation module 110 executing at the backend system 102 (described below). In some instances, the simulation module 158 can collect and integrate the various simulations into the hub application 152, thereby allowing the IoT scenario 162 to include data from the simulated components within the visualized demo.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, JavaScript, Java™, Visual Basic, assembler, Perl®, any suitable version of 4GL, as well as others.

The IoT hub 142 includes a hub application programming interface (API) 150 capable of allowing the IoT hub 142 to receive input from one or more of the other IoT devices 170, the backend system 102, and any external systems (e.g., sensors 190 or data 192). In some instances, the hub API 150 or the hub application 152 itself may be able to contact and access information from some or all of these systems, thereby allowing the IoT hub 142 to manage collection of the relevant data. In some instances, the IoT scenario 162 may have various components subscribe to or publish data being generated by one or more data sources. For the IoT devices 170, this information may be obtained directly at the IoT device 170. Alternatively, the information may be obtained by the IoT hub 142 and shared with or provided to the particular IoT device 170, allowing the IoT hub 142 to assist in managing various connections. Similarly, the IoT hub 142 may collect and/or receive some data indirectly via particular IoT devices 170 or the backend system 102, such as when the IoT hub 142 is limited in processing speed, bandwidth, or for any other suitable reason.

In some instances, the IoT hub 142 is used to manage a plurality of IoT devices 170 associated with the current IoT scenario 162, as well one or more sets of simulated data associated with additional components or devices included in the IoT scenario 162. The IoT scenario 162 represents a defined collection of IoT-capable components within a virtual or physical environment. Each component may be associated with a specific device model (shown as device model 132) that provides a defined visual model of the corresponding device or component that can be presented visually within a visual model. Additionally, the device model can include particular characteristics of the device or component, such as information on how to connect to the corresponding device instance, information on how to simulate input to or output from the particular device, as well as other device-specific information. The IoT scenario 162 can include multiple components, each representing a distinct instance of a particular device or component, which can be presented in an illustrated manner to allow users to visualize the location associated with the IoT scenario 162, such as a factory, home, business, or other suitable location or set of locations. As noted, the IoT hub 142 can communicate with physical and real IoT devices 170 associated with a particular IoT scenario 162 such that live data from those devices 170 can be included within the visualized IoT scenario 162. Further, the IoT hub 142 can access or use components and/or data streams outside of the illustrated system to populate and execute the IoT scenario 162 and its associated visualization. For example, via network 140, the IoT hub 142 can access one or more external sensors 190 and/or external simulated data 192.

The IoT hub 142 includes a graphical user interface (GUI) 148. The GUI 148 may comprise a graphical user interface operable to, for example, allow the user of the IoT hub 142 to view and interact with a visualization of the IoT scenario 162 and the hub application 152. Generally, the GUI 148 provides the particular user with an efficient and user-friendly presentation of business data provided by or communicated within the system. The GUI 148 may comprise a plurality of customizable frames or views having interactive fields, pull-down lists, and buttons operated by the user. For example, the GUI 148 may provide interactive elements that allow a user to interact with a particular component within and/or external to environment 100. Different portions of the IoT scenario 162, such as individual components included therein, may be presented and interactive for and to the user through the GUI 148 via hub application 152. Generally, the GUI 148 may also provide general interactive elements that allow a user to access and utilize various services and functions of a particular component and/or application. For example, touch interfaces with input entered via the GUI 148 (and an associated touchscreen display) may allow users to easily modify the IoT scenario 162, individual components (e.g., IoT and non-IoT devices within the IoT scenario 162), and interactions between various components. In general, the GUI 148 is often configurable, supports a combination of tables and graphs (bar, line, pie, status dials, etc.), and is able to build real-time portals and illustrations, where tabs are delineated by key characteristics (e.g., site or micro-site). Therefore, the GUI 148 contemplates any suitable graphical user interface, such as a combination of a generic web browser, intelligent engine, and command line interface (CLI) that processes information in the platform and efficiently presents the results to the user visually.

As illustrated, the IoT hub 142 includes memory 160, or multiple memories 160. The memory 160 may include any memory or database module and may take the form of volatile or non-volatile memory including, without limitation, magnetic media, optical media, random access memory (RAM), read-only memory (ROM), removable media, or any other suitable local or remote memory component, including one or more in-memory databases. The memory 160 may store various objects or data, including component and device information, information defining or associated with one or more IoT scenarios 162, connection information, business or financial data, user information, component behavior information and access rules, administrative settings, password information, caches, applications, backup data, repositories storing business and/or dynamic information, and any other appropriate information including any parameters, variables, algorithms, instructions, rules, constraints, or references thereto associated with the purposes of the IoT hub 142, the hub application 152, and the system in general. Additionally, the memory 160 may store any other appropriate data, such as VPN applications, firmware logs and policies, firewall policies, a security or access log, print or other reporting files, as well as others. For example, illustrated memory 160 includes the IoT scenario 162 (described above) and device information 164. Device information 164 may include information describing the one or more devices included within the IoT scenario 162, as well as information specific to the IoT hub 142 itself. In some instances, the IoT hub 142 may act both as the hub of the IoT scenario 162 while also being one of the IoT devices included and operating within the IoT scenario 162.

In general, the illustrated IoT hub 142 is intended to encompass any computing device such as a desktop computer, laptop/notebook computer, mobile device, smartphone, personal data assistant (PDA), tablet computing device, one or more processors within these devices, or any other suitable processing device. For example, the IoT hub 142 may comprise a computer that includes an input device, such as a keypad, touch screen, or other device that can accept user information, and an output device that conveys information associated with the operation of the hub application 152 or the IoT hub 142 itself, including digital data, visual information, or a GUI 148, as shown with respect to the hub 142.

The illustrated environment 100 includes one or more IoT devices 170. IoT devices 170 may be any computing device operable to connect to or communicate with the IoT hub 142 and/or the connected and executing IoT scenario 162 managed by the hub application 152, as well as in some instances, one or more external sensors 190, external simulated data 192, other IoT devices 170, and/or the backend system 102, among others, via network 140, as well as with the network 140 itself, using a wireline or wireless connection. Each IoT device 170 can include a desktop computer, a mobile device, a tablet, a server, or any other suitable computer device, such as a sensor attached to, associated with, or integrated into one or more physical components. In general, each IoT device 170 comprises an electronic computer device operable to receive, transmit, process, and store any appropriate data associated with the environment 100 of FIG. 1.

FIG. 1 illustrates an example IoT device 170. A person of skill in the art will understand that various alternative architectures and components may be used for various IoT devices 170, even within a single implementation. As illustrated, the IoT device 170 includes an interface 172, a processor 174, a device application 176, an IoT API 180, a device sensor 182, and memory 184. Interface 172 and processor 174 may be similar to or different to the interface 144 and processor 146 described with regard to the IoT hub 142. In general, processor 174 executes instructions and manipulates data to perform the operations of the IoT device 170. Specifically, the processor 146 can execute some or all of the algorithms and operations described in the illustrated figures, including the operations performing the functionality associated with the device application 176 and the other components of IoT device 170. Similarly, interface 172 provides the IoT device 170 with the ability to communicate with other systems in a distributed environment—including within the environment 100—connected to the network 140.

IoT device 170 executes a device application 176 via processor 174. The device application 176 may perform operations associated with the underlying functionality of the device itself. For example, one IoT device 170 may be a smart thermostat employed in a house or factory. The device application 176 may be the application that manages operation of the thermostat. In addition to this functionality, the device application 176 may include a device monitor 178, which can be used to monitor performance of the IoT device 170 in its normal operations, as well as information related to the environment in which the IoT device 170 is performing. This data may include information related to one or more other devices present in the environment, as well as information about the environment itself. In the thermostat situation, this may include information related to the ambient temperature. The device monitor 178 may collect or monitor information relating to the commands issued by the IoT device 170, readings made at the IoT device 170, instructions received at the IoT device 170 from a user or another connected device, as well as other suitable information. In some instances, a device sensor 182 may be used to collect information associated with the IoT device 170. While described as a “smart” device, the IoT device 170 itself may be a relatively simple device, where information obtained from a device sensor 182 is used to make the IoT device 170 “smart” for use in the IoT scenario 170.

The IoT API 180 can allow the IoT device 170 to provide information to other components and devices within the environment and/or connected within the IoT scenario 162. In some instances, the IoT API 180 or another suitable component can be used to obtain information from one or more of the other devices or data sources within or external to the IoT scenario 162, including some virtual or simulated components. In some instances, the IoT API 180 can work closely with the device application 176 to publish the device's own data or consume information from other devices.

Memory 184 of the IoT device 170 may be similar to or different from the memory 160 of the IoT hub 142. Additionally, the memory 184 (like the other elements of the various IoT devices 170) can be presented in different manners in different IoT devices 170. As illustrated, memory 184 includes a set of device data 186 and a set of publishing and subscription rules 188. The set of device data 186 can store information related to the IoT device 170 itself, information on performance, information on related devices, or any other suitable information associated with the performance of the device 170. In some instances, action rules may be stored in the device data 186, such that in response to particular information from the device sensor 182 or from one or more subscribed data streams, the device application 176 may be affected to cause a change in operation of the device 170 itself. The set of publishing and subscription rules 188 define what information associated with the IoT device 170 is to be published and made available to other devices, including the IoT hub 142, as well as the information which the IoT device 170 is subscribed to in order to consume information and, in some cases, make operational decisions based thereupon.

In general, the backend system 102 may be any suitable backend computing server or system providing support to the IoT hub 142 and the development and modification of the IoT scenarios 162. In some instances, the backend system 102 may provide modeled components for addition to an IoT scenario 162, including information on the devices or components themselves, their projected or allowed inputs and outputs, a 2D or 3D model capable of being included in a visualization of an IoT scenario 162, and, in some instances, simulated data associated with one or more virtual or simulated components. The backend system 102 may be part of an enterprise business application or application suite providing one or more of enterprise relationship management, content management systems, document management, business intelligence analytics, customer relationship management, and other functionality, in addition to managing and providing information associated with one or more IoT scenarios and IoT catalogs.

The illustrated backend system 102 can store information on multiple IoT scenarios 120 and IoT catalogs 130, provide at least a part of that information in response to requests from, for example, the IoT hub 142 or its hub application 152, and provide information on simulated components or devices. In some instances, portions of the backend system 102 may be performed by different and distinct systems or solutions. In one example, some or all of the illustrated IoT catalog 130 may be managed external to the backend system 102. For example, the IoT hub 142 may maintain a version of an IoT catalog 130, or may access other external IoT catalogs (not shown) for retrieving and finding device models and operational information.

As illustrated, the backend system 102 includes an interface 104, a processor 106, a business application 108, an IoT device simulation module 110, and memory 118. In general, the backend system 102 is a simplified representation of one or more systems and/or servers that provide the described functionality and is not meant to be limiting but rather an example of the systems possible. The interface 104 and processor 106 can be similar to or different from the interfaces (144 and 172) and processors (146 and 174) described above. In general, processor 106 executes instructions and manipulates data to perform the operations of the backend system 102, the business application 108, and the device simulation module 110. Specifically, the processor 106 can execute some or all of the algorithms and operations described in the illustrated figures, including the operations performing the functionality associated with the business application 108, the device simulation module 110, and the other components of backend system 102. Similarly, interface 104 provides the backend system 102 with the ability to communicate with other systems in a distributed environment—including within the environment 100—connected to the network 140.

The business application 108 represents an application, set of applications, software, software modules, or combination of software and hardware used to perform operations related to operations of the backend system 102. The business application 108 may be associated with an enterprise business application or application suite providing one or more of enterprise relationship management, content management systems, document management, business intelligence analytics, or customer relationship management, among others. In some instances, the business application 108 may represent a visual enterprise solution, such as SAP's 3D Visual Enterprise. The hub application 152 executing at the IoT hub 142 may be associated with or separate from the business application 108. Additionally, the business application 108 may be associated with the device simulation module 110 in some instances.

The device simulation module 110 may, in some instances, be located as illustrated at the backend system 102. In other instances, some or all of the functionality may be located at and executed by the IoT hub 142, or the functionality may be shared across the systems. The device simulation module 110 is meant to provide an execution platform to assist in simulating data associated with one or more simulated components or devices within a particular IoT scenario, and to provide suitable inputs and processing of data as that which would be performed should an actual version of the simulated device be implemented into a live system. The device simulation module 110 can simulate multiple devices, as needed, with multiple instances running concurrently. In some instances, entire IoT scenarios may be built fully around simulated devices, without any physical IoT devices 170 present.

The device simulation module 110, as illustrated, includes a set of simulated device operations 112, a set of simulated output 114, and a set of simulated connections 116. The simulation itself is created based on detailed models available from one or more catalogs, or alternatively, as designed by a user or designer. The simulated operations 112 are meant to mirror or simulate those of an actual implementation of the modeled device, such that testing and experimentation is available. The simulated operations 112 may include a set of connections 116, or subscriptions to, one or more other physical or simulated devices. Those connections 116 can pull in simulated or real data to affect how the device operates or responds to such data. The simulated output 114 is the result of the operations of the device in combination with any subscriptions or effects from the data being considered by the simulated device.

As noted, the simulated device can be added to existing IoT scenarios 162 (or 120) as developed. A visualization of the modeled device can be added to the illustrated IoT scenario 162 (or 120), while a simulation module 110 (located at the backend system 102, the IoT hub 142, or elsewhere) provides the processing and operations associated with the modeled device for interaction with other real and/or simulated devices.

Memory 118 may be may be similar to or different from the memory 160 of the IoT hub 142 or memory 184 of the IoT device 170. As illustrated, memory 118 includes one or more IoT scenarios 120, one or more IoT catalogs 130, and a set of business data 136. The one or more IoT scenarios 120 may include one or more pre-defined scenarios, template scenarios, or scenarios generated at one or more IoT hubs 142 and persisted at the backend system 102. Each scenario 120 can include a scenario model 122 defining the different devices (both physical and simulated) to be included within the IoT scenario 120. The scenario model 122 can include one or more IoT devices 124, one or more non-IoT devices 126, and information on how different IoT devices are connected in the IoT connection information 128. Non-IoT devices 126 may be included in a scenario to represent actual devices or components within the illustrated space, such as a factory, which are not considered things within the Internet of Things. In those instances, the non-IoT devices 126 may be devices that do not have the capability to be integrated into the IoT scenario 120, devices that are capable of being integrated but have not yet been, or other devices that are not linked or in a state of being interconnected with the current IoT scenario 120. The IoT devices 124 may include one or more devices corresponding to IoT devices 170, as well as one or more simulated devices. The IoT connection information 128 can describe the data subscribed to and published by each of the devices within the scenario 120.

The IoT catalog 130 represents a plurality of device models 132 and scenario models 134 that can be maintained and prepared for inclusion in one or more IoT scenarios in the case of the device models 132 or used to start a new IoT scenario in the case of the scenario models 134. The device models 132 can include a modeled visualization of the corresponding device, which can then be added to a particular IoT scenario 120 (or 162) visualization. Additionally, the device models 132 can provide operating characteristics about each device, allowing instances of the device models 132 to be added to different IoT scenarios to simulate operations of those devices as needed. Once added to particular IoT scenarios, parameters or operating characteristics of each instance of the device model 132 can be modified to simulate appropriate scenarios and/or factors. Similarly, scenario models 134 may include pre-built or template scenarios containing one or more devices therein. Each of the device models 132 can be associated with a particular simulation or physical device (i.e., a particular IoT device 170).

Business data 136 may include any suitable business data associated with the IoT scenarios 120 or 162, including information which may influence the operation of particular simulated devices, or simulated information which may affect operations of actual physical devices.

As illustrated and described herein, one or more external sensors 190 and/or external simulated data 192 may be associated with a particular IoT scenario. For example, information from external systems which may affect operations at a factory (e.g., business conditions, output at other locations, available energy or operational resources, external temperatures, etc.) may be subscribed to or monitored and used to affect or modify the behavior of the IoT scenario 120 or 162.

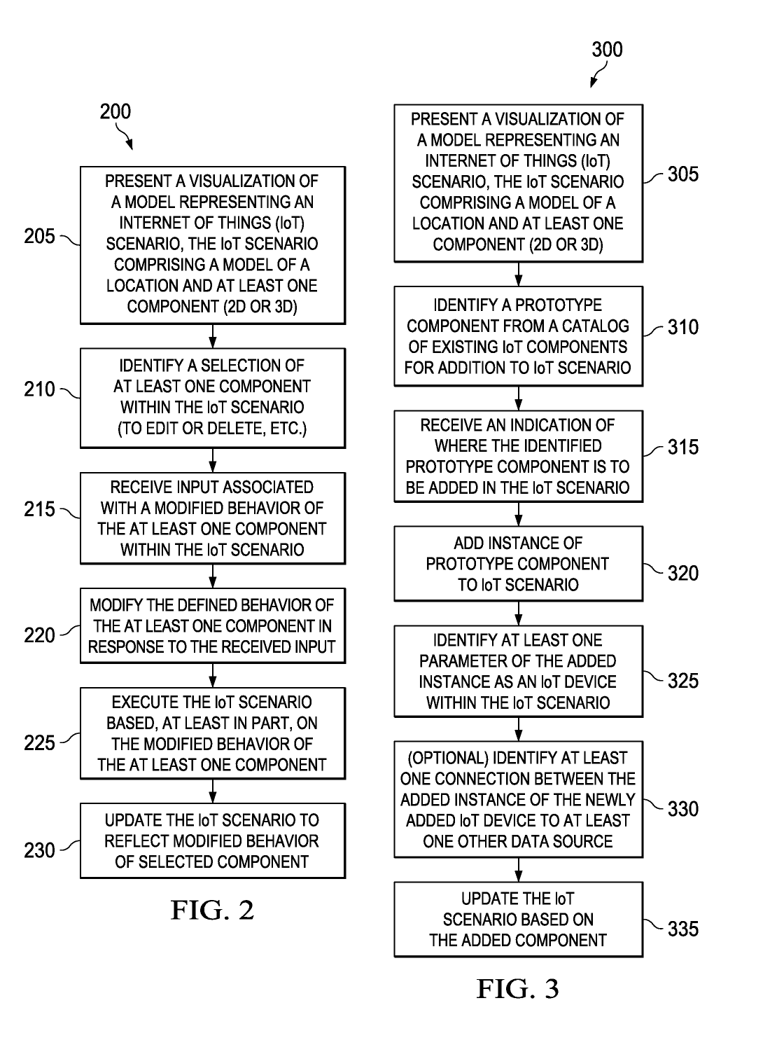

FIG. 2 is a flowchart of example operations performed to modify a simulation of an IoT scenario. Specifically, FIG. 2 is described based on one or more interactions with a user at a mobile touch-based tablet, phone, or other computing device, where a visualization of the IoT scenario (e.g., IoT scenario 162) is presented on the device, and where existing devices are being modified within the IoT scenario. For clarity of presentation, the description that follows generally describes method 200 in the context of the system 100 illustrated in FIG. 1. However, it will be understood that method 200 may be performed, for example, by any other suitable system, environment, software, and hardware, or a combination of systems, environments, software, and hardware as appropriate.

At 205, a visualization of a model representing an IoT scenario is presented. The IoT scenario can include a model of the location in which the IoT scenario is based, and may be a two-dimensional or three-dimensional representation of the location. The visualization can include one or more visual models of devices, with each device representing a simulated or physical device. The physical devices are present in the corresponding real-world location, while the simulated devices may be potential devices to be added to the location at a later date. Additionally, one or more devices may be present in the visualization that are not associated with the IoT implementation, where those devices do not interact with one or more of the other devices within the location or other external devices. The parameters or actions associated with one or more of the devices, whether currently included within the IoT implementation, can be updated through this method.

At 210, a selection of at least one component or device within the visualized IoT scenario is identified. The selection of the component or device may be associated with a request to modify, delete, or otherwise change the selected device. At 215, input associated with the modified behavior of the selected device or component is received. The received input may include requests to add, remove, or modify a subscription to a particular device or data stream to the component (whether to a local or remote/external device or stream); add, remove, or modify a published data stream for the selected device; modify the location of the selected device within the visualized location; modify the output of the device from a simulated set of data to actual data received in the real world (or vice versa); modify the behavior of the selected component based on particular subscription data or data streams; as well as any other suitable change. At 220, the defined behavior of the selected device or component is modified in response to the received input. At 225, the IoT scenario is executed based, at least in part, on the modified behavior of the selected device or component. In doing so, the effect of the changes can be viewed via the visualized representation of the IoT scenario. Upon reviewing the effect of the changes, the user or administrator making the change can determine whether the changes should be kept or discarded. If the changes are to be kept, the IoT scenario can be updated at 230 to reflect the changes made.

FIG. 3 is a flowchart of example operations performed to add a new component to an existing IoT scenario. Specifically, FIG. 3 is described based on one or more interactions with a user at a mobile touch-based tablet, phone, or other computing device, where a visualization of the IoT scenario (e.g., IoT scenario 162) is presented on the device, and where additional devices are being added to the visualization and IoT scenario. For clarity of presentation, the description that follows generally describes method 300 in the context of the system 100 illustrated in FIG. 1. However, it will be understood that method 300 may be performed, for example, by any other suitable system, environment, software, and hardware, or a combination of systems, environments, software, and hardware as appropriate.

At 305, a visualization of a model representing an IoT scenario is presented. The IoT scenario can include a model of the location in which the IoT scenario is based, and may be a two-dimensional or three-dimensional representation of the location. The visualization can include one or more visual models of devices, with each device representing a simulated or physical device. The physical devices are present in the corresponding real-world location, while the simulated devices may be potential devices to be added to the location at a later date. Additionally, one or more devices may be present in the visualization that are not associated with the IoT implementation, where those devices do not interact with one or more of the other devices within the location or other external devices. The parameters or actions associated with one or more of the devices, whether currently included within the IoT implementation, can be updated through this method. Method 300 may be executed before or after method 200 of FIG. 2.

At 310, a prototype component or device is identified to be added to the visualized model of the IoT scenario. The prototype component or device may be identified from an existing catalog of IoT devices or components (similar to IoT catalog 130 of FIG. 1) or an external catalog of IoT devices or components (e.g., cloud-based or available from a third party). In other instances, the prototype component may be generated by a designer or user, in some based on a pre-existing component, or the prototype component may be based on a generic component, with additional inputs, outputs, and operations added later.

At 315, an indication of where the identified prototype component is to be added within the visualization is received. The component may be associated with specific limitations on where it may be added—for example, some components may be required to be placed on a ceiling (e.g., a fan) or a wall (e.g., a monitor or television), while others must be placed on the floor (e.g., an air conditioning unit). Additionally, prior devices or components may not be movable, such that the identified location may need to be empty of other devices or components. At 320, an instance of the identified prototype component is added to the IoT scenario in the location identified. Changes to the particular instance of the component can be made to modify only that particular instance, or the change can be made global to affect all future instances. To that end, one or more parameters associated with the instance can be added to make the instance a thing, or IoT device, within the IoT scenario at 325. Those parameters can include any relevant information. For example, the parameters can identify the operation parameters of the device. Alternatively, the parameters can define a subscription to a data stream for the device, or instead, a set of information to be published for other devices or components to potentially consume. An example structure of publisher information may be represented as follows:

```
{
    “deviceType”:“sensor”,
    “groupId”:“factory”,
    “param”:“temperature”,
    “valueType”:“FLOAT”²,
    “valueDimension²:“Celcius”
}
```

An example structure of subscription information may be represented as follows:

```
{
    “groupId”:“factory”,
    “param”:“temperature”
}
```

If the parameter includes a subscription to a particular data stream or device, at 330, the connection between the instance of the prototype component and the at least one other data source is identified and included in the definition of the prototype component. At 335, the IoT scenario is persisted and updated to include the added prototype component.

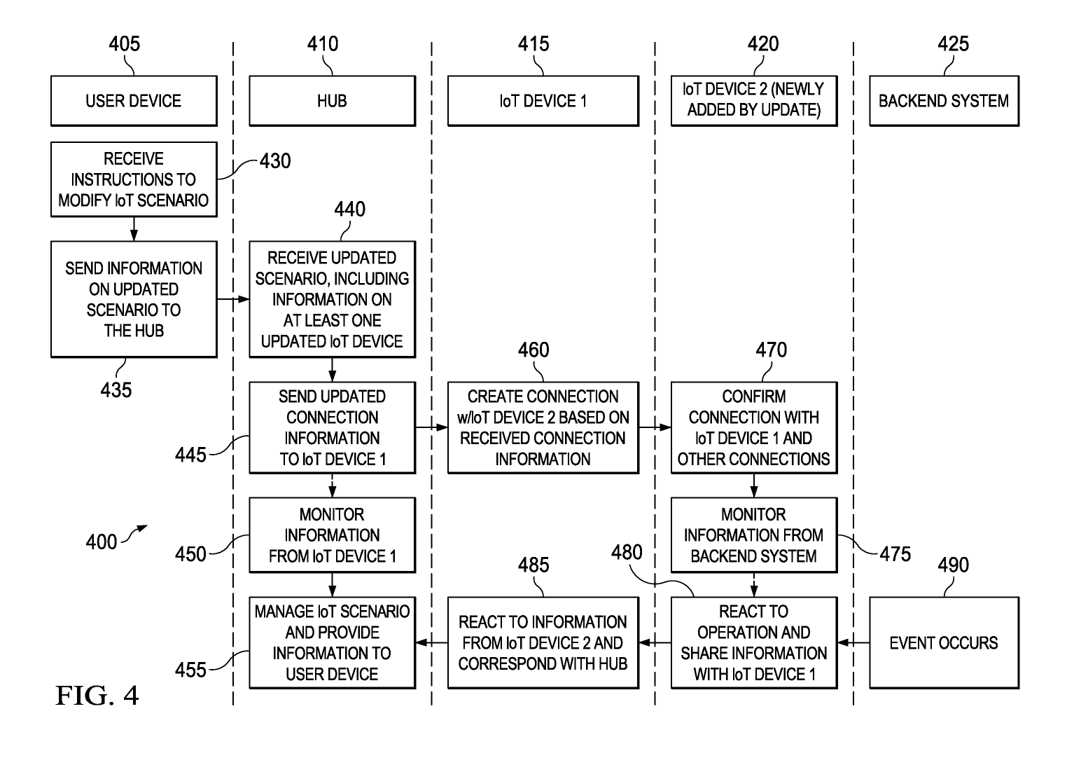

FIG. 4 is a swim lane diagram of example operations performed in response to a modification to an IoT scenario. In the illustrated flow, five devices and components are considered: user device 405, hub device 410, IoT device 1 (415), IoT device 2 (420), and backend system 425. In the present illustration, the user device 405 and the hub device 410 are described as two separate devices. In other instances, the user device 405 and the hub device 410 may be the same device or different devices. Communications with the backend system 425 may be performed by the hub device 410 directly, or, alternatively, through a one more of the IoT devices.

At 430, the user device 405 receives instructions from a user to modify the IoT scenario. At 435, the user devices sends information related to the updated scenario to the hub 410.

At 440, the hub receives the updated scenario information from the user device. At 445, the hub updates the IoT scenario and sends the updated connection information to IoT device 1.

In response to receiving the updated connection information, at 460 the IoT device 1 (415) creates a connection with IoT device 2 (415) based on the received connection information. In the current example, IoT device 1 (415) is a part of the existing IoT scenario. The new connection to IoT device 2 (420) can be to a newly added device into the IoT scenario, a new connection to an existing IoT device, or an activation of a previously non-IoT device into an IoT device, where the previously non-IoT device was present in the scenario but inactive in the IoT communications and scenario. In the present scenario, IoT device 1 (415) connects directly with IoT device 2 (420). In response to the attempt to create the connection, IoT device 2 confirms the connection at 470. In the current illustration, additional connections between IoT device 2 and the backend system are created at 470, such that IoT device 2 (420) reacts to simulated input from a simulated device simulated at the backend system 425. At 475, IoT device 2 (420) monitors the data stream of the backend system to which it is subscribed.

At 490, an event can occur for the simulated device via the backend system 425. In response to the event, at 480 the IoT device 2 (420) can react to the operation, perform any operation, and subsequently share updated information about itself and its actions to IoT device 1 (415). In some instances, IoT device 2 (420) may act as a pass-through for information from the simulated device, simply passing information from the backend system 425 to IoT device 1 (415). At 485, IoT device 1 (415) can react to the information provided by IoT device 2 (420), perform any corresponding action based on the information, and then communicate the updated information and/or actions to the hub 410.

After the hub 410 sent the information on the new connection to IoT device 1 (415) at 445, the hub 410 moved to monitor information from IoT device 1 (415) at 450. At 455, information from IoT device 1 (415) is received. In response to the received information, the hub 410 continues to manage the IoT scenario and provides an illustration or notification of events, actions, and results to the user device.

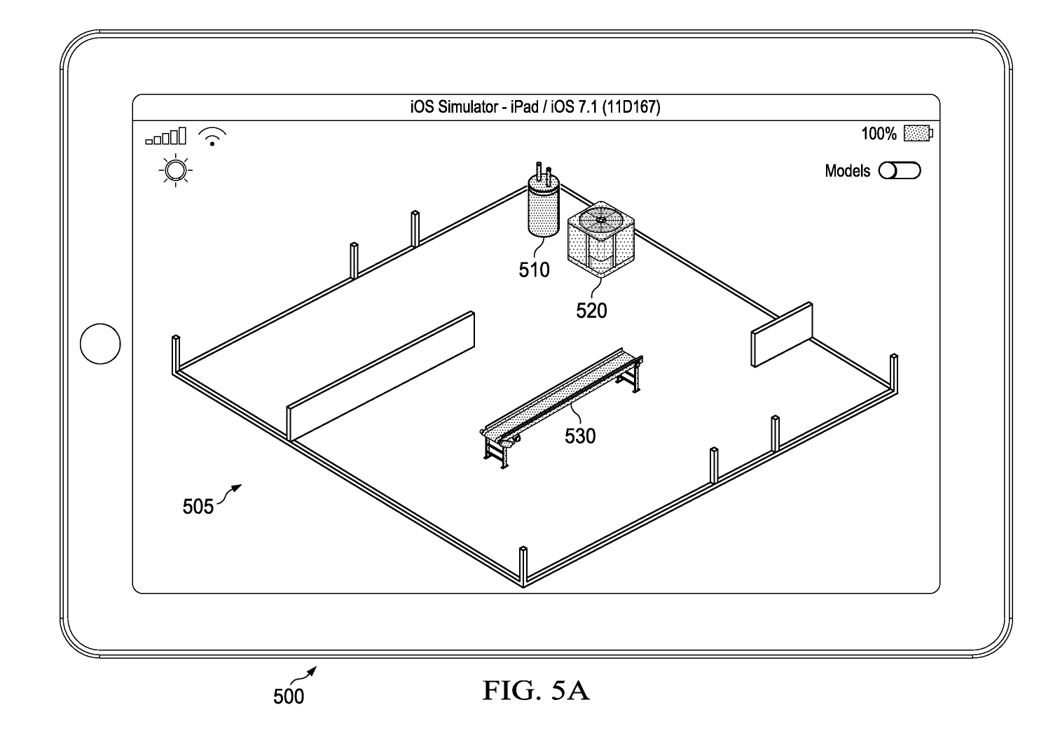

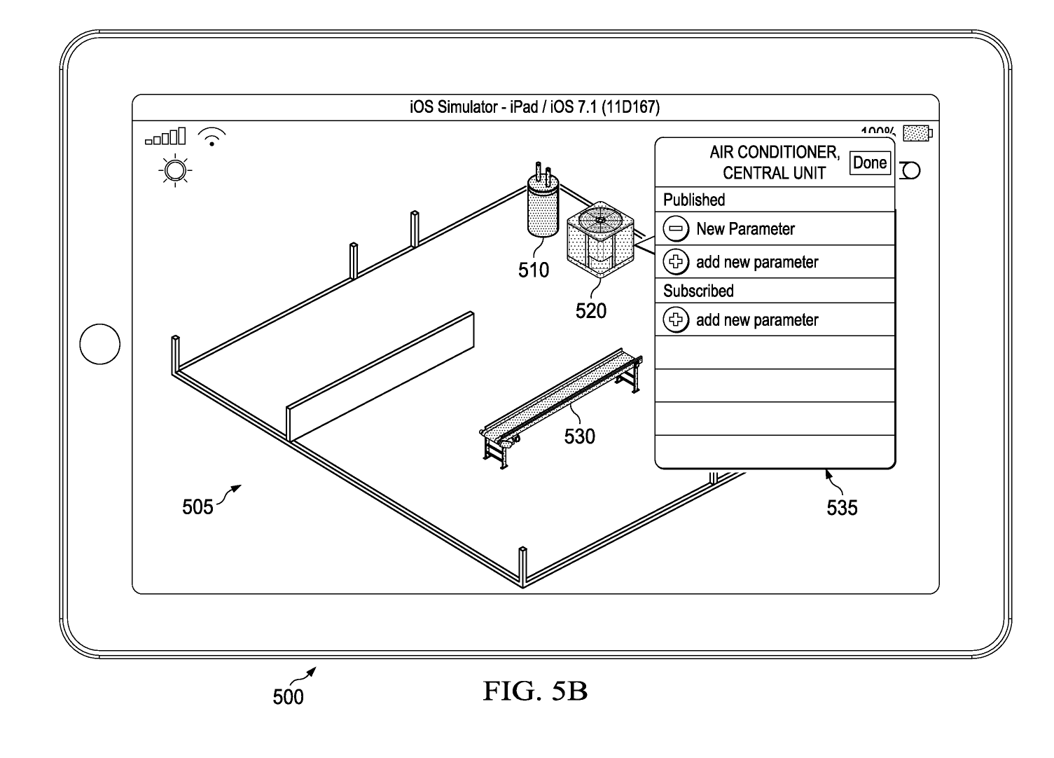

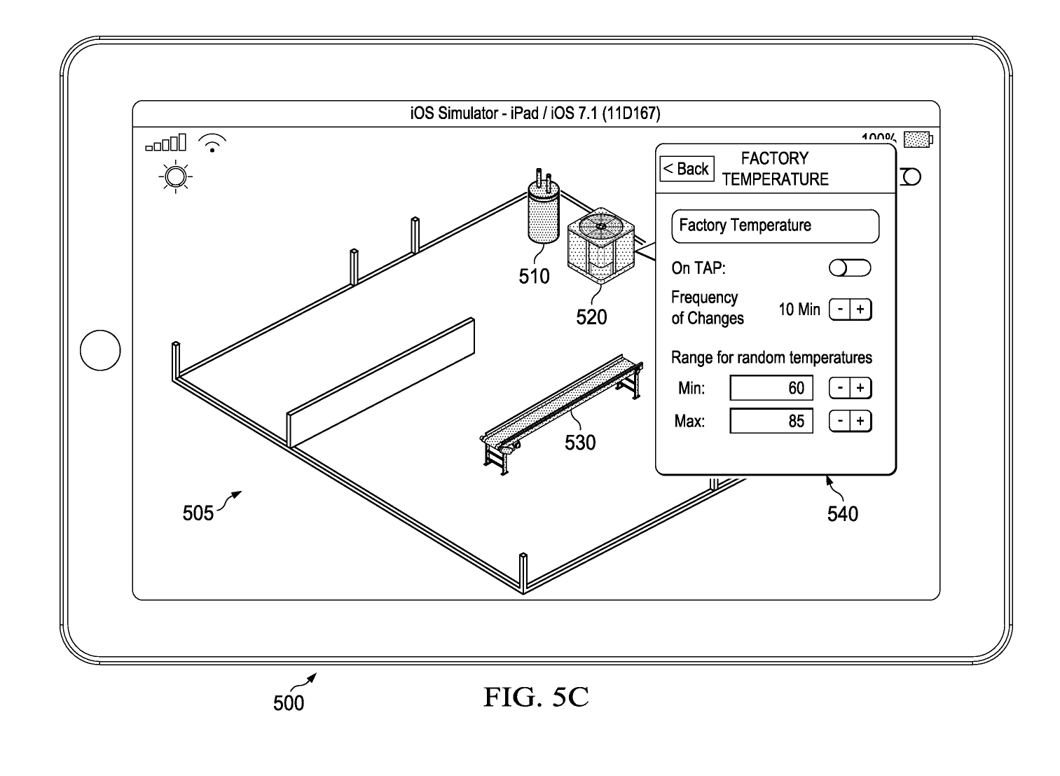

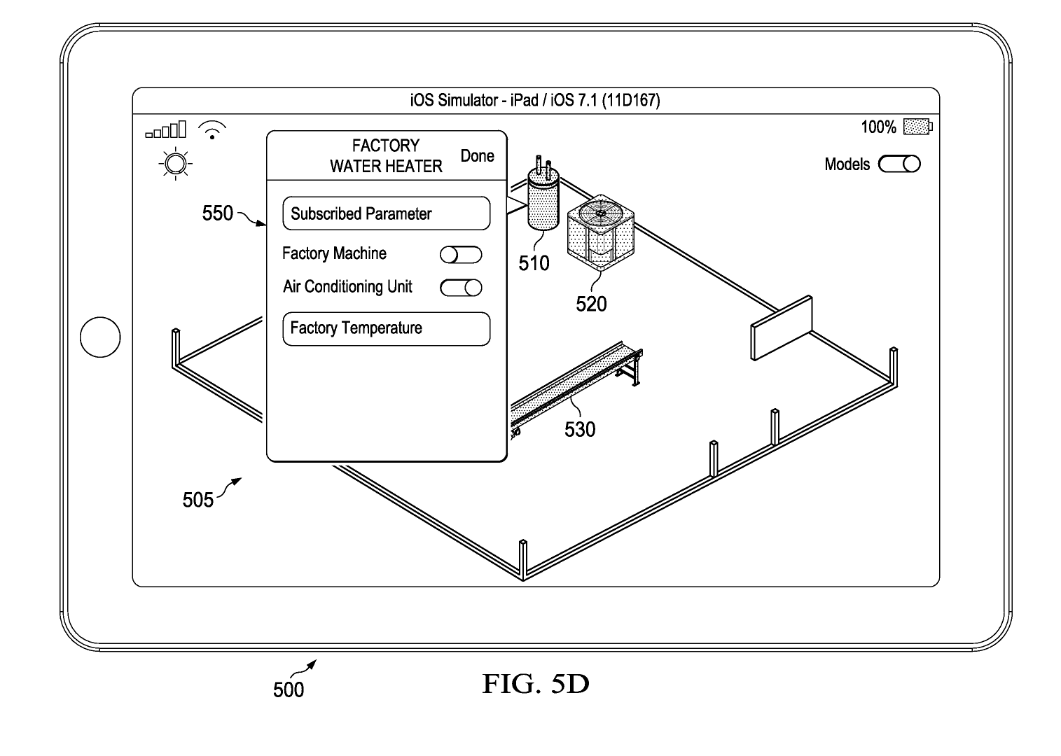

FIGS. 5A-D are illustrative screenshots related to the creation, modification, and simulation of IoT scenarios. The example illustration is meant to be one of many possible solutions based on the description herein. The illustration 500 of FIG. 5A represents a virtual representation of an IoT system as presented on a user device. The IoT system represents a set of modeled devices within a factory 505, the IoT devices including a water heater 510, an air conditioning unit 520, and a general factory machine 530, such as a lathe. As illustrated, the water heater 510 and the machine 530 are connected to the internet of things in the current scenario and are denoted as such by their shading. The designation of particular devices as IoT devices may be based on shading, coloring, bolding, or other appropriate distinctions. The air conditioning unit 520, however, is a non-IoT device at this time.

FIG. 5B represents a selection of the air conditioning unit 520 within the visualization of the IoT scenario. The selection may be a touch selection or input on the visualized model of the air conditioning unit 520. Response to the input, input screen 535 may be displayed. The input screen 535 includes a small reference to the air conditioning unit 520, allowing users to understand and see which component is being updated. The user can use the input screen 535 to add, edit, or delete published parameters from the device or subscribed parameters from other devices. FIG. 5C illustrates an example screen 540 for adding a new published parameter associated with the air conditioning unit 520. The new parameter, renamed “Factory Temperature,” can provide information associated with the set temperature to which the air conditioning unit 520 is attempting to reach. The parameter can be named, and the effects of the parameter can be updated. For example, the ranges of temperatures may be defined, as well as the frequency of changes. This information can be used later to cause actions to occur in one or more of the other devices based on the published output of the Factory Temperature parameter. The new parameter is then saved and available for later use. In some instances, the Factory Temperature may be an actual temperature reading read directly from a physical air conditioning unit already included in the factory.

FIG. 5D illustrates an example of adding a subscription to one of the IoT devices, here the water heater 510. Again, the user can tap or touch the water heater 510 to bring up a menu to add a new published parameter or to subscribe to a new parameter. In this example, the selection is to add a new subscription. Upon doing so, a new input screen 550 is presented. The input screen 550 identifies the other IoT devices with published parameters, here the Factory Machine and the Air Conditioning Unit. In this illustration, the Air Conditioning Unit can be selected, with the parameter “Factory Temperature” (as previously added) being selected. While not illustrated, the solution may then allow users to define actions to be taken when the subscribed parameters meet or reach certain thresholds, thereby viewing the effects of various actions and events.

The preceding figures and accompanying description illustrate example systems, processes, and computer-implementable techniques. While the illustrated systems and processes contemplate using, implementing, or executing any suitable technique for performing these and other tasks, it will be understood that these systems and processes are for illustration purposes only and that the described or similar techniques may be performed at any appropriate time, including concurrently, individually, or in combination, or performed by alternative components or systems. In addition, many of the operations in these processes may take place simultaneously, concurrently, and/or in different orders than as shown. Moreover, the illustrated systems may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computerized method performed by one or more processors, the method comprising:
presenting a visualization of a model representing an Internet of Things (IoT) scenario on a touch-capable display, the IoT scenario comprising a model of a location and two or more components, the touch-capable display capable of receiving touch-based input from a user interacting with the presented visualization via the display;
identifying a selection of a particular component within the IoT scenario via a touch-based command, the touch-based command corresponding to a touch of the particular component within the presented visualization;
receiving input defining a modified behavior of the particular component within the IoT scenario; and
executing the IoT scenario based on the modified behavior of the particular component.

2. The method of claim 1, wherein the particular component comprises a component included in the visualized model and not previously integrated into the IoT scenario.

3. The method of claim 2, wherein receiving input defining the modified behavior or the particular component within the IoT scenario comprises receiving an instruction to cause the particular component to subscribe to data stream associated with at least one other data source.

4. The method of claim 3, wherein the data stream associated with at least one other data source comprises a data stream from a component included in the IoT scenario.

5. The method of claim 4, wherein the data stream from the component included in the IoT scenario comprises a data stream simulated associated with the IoT model.

6. The method of claim 4, wherein the data stream from the component included in the IoT scenario comprises real data generated from a real object corresponding to the component included in the IoT scenario.

7. The method of claim 3, wherein the data stream associated with the at least one other data source comprises a data stream generated external to the IoT scenario.

8. The method of claim 7, wherein the data stream generated external to the IoT scenario comprises real data generated from a non-virtual sensor published data external to the IoT scenario.

9. The method of claim 2, wherein receiving input defining the modified behavior or the particular component within the IoT scenario comprises receiving an instruction to cause the particular component to publish a data stream associated with the particular component.

10. The method of claim 9, wherein the published data stream associated with the particular component is generated by a simulation of a modeled device corresponding to the particular component.

11. The method of claim 10, wherein the published data stream associated with the particular component is generated by a sensor associated with a non-virtual sensor associated with a physical device corresponding to the particular component.

12. The method of claim 1, wherein identifying a selection of a particular component within the IoT scenario via a touch-based command comprises identifying a selection of a particular component from a catalog associated with the visualized model, and wherein receiving input defining the modified behavior of the particular component within the IoT scenario comprises receiving instructions to add an instance of the particular component to the visualized model.

13. The method of claim 12, further comprising modifying the defined behavior of the particular component in response to the received input.

14. The method of claim 1, wherein the model representing the IoT scenario is managed across a plurality of devices and is viewable on a hub device, wherein the hub device connects to at least one backend system to receive IoT scenario-related information for use in the IoT scenario.

15. A computer-readable media, the computer-readable media comprising computer-readable instructions embodied on tangible, non-transitory media, the instructions operable when executed by at least one computer to:
present a visualization of a model representing an Internet of Things (IoT) scenario on a touch-capable display, the IoT scenario comprising a model of a location and two or more components, the touch-capable display capable of receiving touch-based input from a user interacting with the presented visualization via the display;
identify a selection of a particular component within the IoT scenario via a touch-based command, the touch-based command corresponding to a touch of the particular component within the presented visualization;
receive input defining a modified behavior of the particular component within the IoT scenario; and
execute the IoT scenario based on the modified behavior of the particular component.

16. The computer-readable media of claim 15, wherein the particular component comprises a component included in the visualized model and not previously integrated into the IoT scenario.

17. The computer-readable media of claim 16, wherein receiving input defining the modified behavior or the particular component within the IoT scenario comprises receiving an instruction to cause the particular component to subscribe to data stream associated with at least one other data source, and wherein the data stream associated with at least one other data source comprises a data stream from a component included in the IoT scenario.

18. The computer-readable media of claim 16, wherein receiving input defining the modified behavior or the particular component within the IoT scenario comprises receiving an instruction to cause the particular component to publish a data stream associated with the particular component, and wherein the published data stream associated with the particular component is generated by a simulation of a modeled device corresponding to the particular component, and wherein the published data stream associated with the particular component is generated by a sensor associated with a non-virtual sensor associated with a physical device corresponding to the particular component.

19. The computer-readable media of claim 15, wherein identifying a selection of a particular component within the IoT scenario via a touch-based command comprises identifying a selection of a particular component from a catalog associated with the visualized model, and wherein receiving input defining the modified behavior of the particular component within the IoT scenario comprises receiving instructions to add an instance of the particular component to the visualized model.

20. A system comprising:
one or more processors; and
a computer-readable medium storing instructions executable by the one or more processors to perform operations comprising:
presenting a visualization of a model representing an Internet of Things (IoT) scenario on a touch-capable display, the IoT scenario comprising a model of a location and two or more components, the touch-capable display capable of receiving touch-based input from a user interacting with the presented visualization via the display;
identifying a selection of a particular component within the IoT scenario via a touch-based command, the touch-based command corresponding to a touch of the particular component within the presented visualization;
receiving input defining a modified behavior of the particular component within the IoT scenario; and
executing the IoT scenario based on the modified behavior of the particular component.
